(19) United States
(12) Patent Application Publication
(10) Pub. No.: US 2004/0097256 A1
(43) Pub. Date: May 20, 2004

(54) Protective cover

(76) Inventor: Clemens Kujawski, Munchen (DE)

Correspondence Address: William E Vaughan, Bell Boyd & Lloyd, PO Box 1135, Chicago, IL, 60690-1135, US

(21) Appl. No.: 10/362,988

(22) PCT Filed: Aug. 23, 2001
(86) PCT No.: PCT/DE01/03220

(30) Foreign Application Priority Data
Aug. 31, 2000 (DE) 100 42 946.7

(51) Int. Cl. H04B 1/034

(52) U.S. Cl. 455/550.1; 455/575.8; 455/95

(57) ABSTRACT

A protective casing is provided for a mobile communication terminal, wherein the protective casing includes an input and/or output device and an interface for transmitting signals between the input and/or output device and the mobile communication terminal, and wherein the input and/or output device is arranged on a side of the protective casing which is on the inside of the protective casing in a closed state.

The present invention relates to a protective casing for a mobile communication terminal and to a set which includes both a mobile communication terminal and a corresponding protective casing.

### BACKGROUND OF THE INVENTION

Modern mobile communication terminals, particularly mobile radios, but also pagers or similar appliances, are opening up more and more multimedia applications, such as Internet access or SMS, to the user. On the other hand, such mobile appliances are intended to get smaller and smaller, which inevitably means that there is less and less space available for the input and output units required for multimedia applications. To solve this problem, one approach to date has involved adapting the applications to the circumstances of the communication terminal. Thus, by way of example, the WAP standard has been developed for Internet access using appliances which have only small screens, such as mobile radios. In some cases, attempts are made to solve the problem via suitable software; for example, by providing the communication terminals with an alterable context-dependent keypad assignment. One example of this is the “T9 mode” for simple input of alphanumeric characters using a numeric keypad, which is used for inputting SMS messages in modern appliances. In other appliances, the problem of an excessively small keypad is solved by a folding keypad on the appliance, but this makes the appliance relatively large, heavy and unwieldy for normal use as a mobile radio.

It is an object of the present invention to provide an alternative to this prior art.

### SUMMARY OF THE INVENTION

This object is achieved by a protective casing for a mobile communication terminal, and by a set which includes both a mobile communication terminal, and a corresponding protective casing, in which the protective casing has an input and/or output device and an interface for transmitting signals between the input and/or output device and the mobile communication terminal.

This protective casing either can be a case which completely surrounds the communication terminal or else a cover for the touch-sensitive parts of the communication terminal, particularly the keypad and the display. In this context, the protective casing can be in the form of a hard shell, a soft protective casing or else a cushioned protective casing, for example.

For many appliances, such a protective casing already has been provided. This protective casing generally has large, completely unused surfaces on which there is a relatively large amount of space available for input and output units. The inventive integration of input and output devices in the protective casing therefore results in no or only minimal additional space being required on the communication terminal itself. The communication terminals themselves become no heavier and they also can be used without the protective casing as before.

The fact that the protective casing frequently has a way of being attached, such as to the belt, means that many users always have the protective casing with them anyway, whereby it is not necessary to carry around any additional appliance, such as a chatboard.

The interface used is preferably a standard interface which is already available anyway in almost all mobile radios. In this context, this can, in principle, involve a short-range wireless interface; for example, an infrared interface or a Bluetooth interface. Preferably, however, an interface with a plug connection for connecting the input and/or output device to the mobile communication terminal is used. This plug connection is preferably in the form of a connection to a standard input/output jack on the mobile radio; for example, the “extension connector” for a charger or a motor-vehicle hands-free system. This choice of interface allows the communication terminals to be produced as before without any additional complexity.

The plug connection also can be used to ensure that the input and output units are supplied with power in the protective casing.

In one preferred set including a communication terminal and a protective casing, the communication terminal has a control device which, when the mobile communication terminal is connected to the protective casing's interface, automatically puts a displayed item on a display on the mobile communication terminal into a desired orientation with respect to the protective casing's input and/or output device. As such, the communication terminal automatically identifies when there is a connection to the protective casing's input and/or output device and this input and/or output device is therefore available for use. Accordingly, the displayed item is rotated on the display such that, by way of example, the user has a keypad on the protective casing and the display on the mobile communication terminal oriented so as to match one another.

In another preferred embodiment of the set, the mobile communication terminal has, on a front side, a first display for use with an integrated input device on the mobile communication terminal. On the rear side, there is a second display for use with the protective casing's input and/or output device. This is expediently a larger display which covers, by way of example, a large part of the rear side. When the mobile communication terminal is connected to the protective casing's interface, a corresponding changeover device in the mobile communication terminal then automatically changes over from the first display to the second display, so that, when an additional large keypad is used in the protective casing, for example, there is a correspondingly large display available.

The present invention is explained in more detail below using exemplary embodiments with reference to the appended drawings. The features presented below and the features which have already been described above can be fundamental to the present invention not just in the combinations cited but also separately or in other combinations.

Additional features and advantages of the present invention are described in, and will be apparent from, the following Detailed Description of the Invention and the Figures.

### BRIEF DESCRIPTION OF THE FIGURES

FIG. 1 shows a perspective view of an inventive set in line with a first exemplary embodiment, including a mobile radio and a case.

FIG. 2 shows a schematic longitudinal section through an inventive set in line with a second exemplary embodiment, including a mobile radio and a cover.

### DETAILED DESCRIPTION OF THE INVENTION

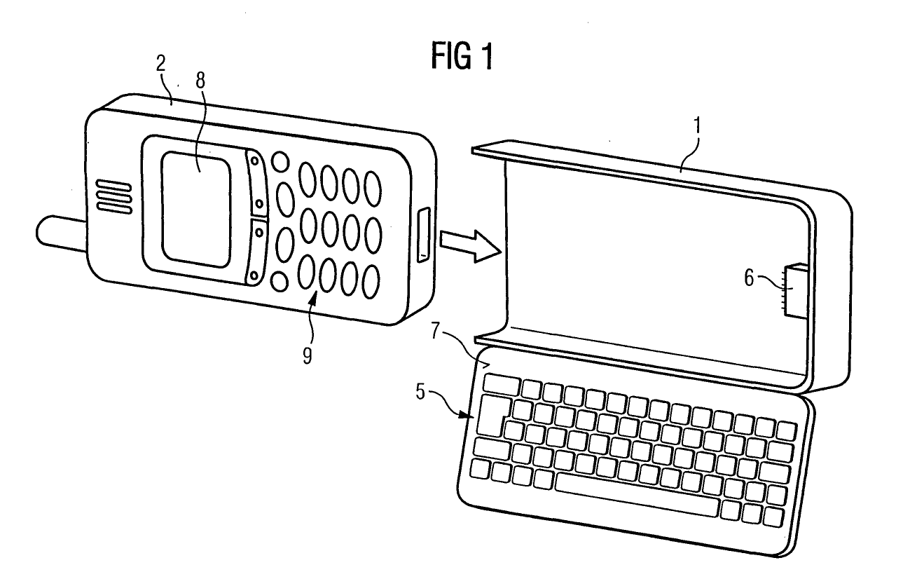

In the exemplary embodiment shown in FIG. 1, the inside of the cover of a case 1 incorporates an alphanumeric keypad 5 for convenient input of short messages or e-mails, for example. This keypad can be designed on the basis of a normal keypad and additionally can have a cursor control, such as a joystick, arranged between the G, H and B keys, or the like.

The protective casing is provided for a commercially available mobile radio 2 having the normal display 8 and a normal keypad 9.

As FIG. 1 shows, the mobile radio 2 is inserted into the case 1 in the direction of the arrow. In the process, a DC connection between the mobile radio and the keypad 5 is automatically made via a plug connection 6 which engages in the connector (e.g., an “extension connector” or “Lumberg connector,” not visible in FIG. 1) which is in the normal position at the bottom in the mobile radio 2. Such a plug connection also can, in principle, be used to supply power to the keypad 5. The plug connection 6 is permanently integrated in the case 1.

In one particularly preferred exemplary embodiment, the mobile radio 2 contains a control device which automatically identifies (when the mobile radio is on) when the mobile radio 2 is in the case 1 and when the plug connection 6 has been plugged into the connector. As soon as this connection to the keypad 5 has been identified, the control device automatically rotates the displayed item on the display 8 on the mobile radio 2 through 90° so that the mobile radio conveniently can be used to edit e-mails and short messages and any other texts on the large alphanumeric keypad 5. Such rotation is possible particularly in the case of “dot matrix displays”.

In another embodiment, the rear side of the mobile radio has a second large display. The mobile radio is then plugged into the case with the keypad at the bottom. When the connection between the mobile radio and the keypad is identified by virtue of the plug connection which has been made, a corresponding changeover device automatically changes over from the front display to the rear display, so that the user has not just a convenient keypad available but also an easily readable display with a large row width.

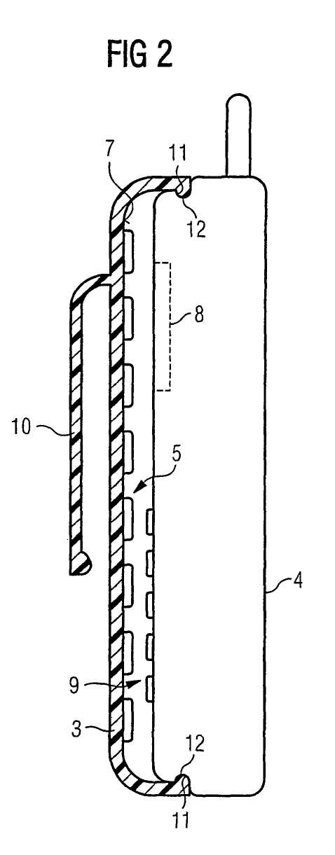

FIG. 2 shows another simple embodiment in which the set includes a mobile radio 4 and a protective cover 3. In this arrangement, the protective cover 3 is in the form of a second top shell and covers merely the front side of the mobile radio 4 with the keypad 9 and the display 8. To this end, the edge of the front side of the mobile radio 4 has a peripheral groove 12 into which a corresponding latching edge 11 of the protective cover 3 engages.

On the inside 7 of the protective cover 3 there is a relatively large alphanumeric keypad 5. On the outside, a belt clip 10 is attached to the protective cover 3.

The connection between the keypad 5 in the cover 3 and the mobile radio 4 again can be made via a plug connection; for example, using a cable (not shown). In principle, however, a corresponding plug connection also can be arranged on the protective cover 3 at a suitable point on the outside, this plug connection being connected to a suitable connector in the mobile radio 4.

Although the present invention has been described with reference to specific embodiments, those of skill in the art will recognize that changes may be made thereto without departing from the spirit and scope of the present invention as set forth in the hereafter appended claims.

1. A protective casing (1, 3) for a mobile communication terminal (2, 4) having an input and/or output device (5) and an interface for transmitting signals between the input and/or output device (5) and the mobile communication terminal (2, 4),
where the input and/or output device (5) is arranged on a side (7) of the protective casing (1, 3) which is on the inside in the closed state.

2. The protective casing as claimed in claim 1, characterized by an alphanumeric keypad (5).

3. The appliance as claimed in claim 1 or 2, characterized in that the interface has a plug connection (6) for connecting the input and/or output device (5) to the mobile communication appliance (2, 4).

4. The protective casing as claimed in claim 3, characterized in that the plug connection (6) is designed for connection to a standard input/output jack on a mobile radio (2, 4).

5. A set comprising a mobile communication terminal (2, 4) and a protective casing (1, 3) as claimed in one of the preceding claims.

6. A set, particularly as claimed in claim 5, comprising a mobile communication terminal (2, 4) and a protective casing (1, 3), where the protective casing has an input and/or output device (5) and an interface for transmitting signals between the input and/or output device (5) and the mobile communication terminal (2, 4), characterized in that the mobile communication terminal has a control device which, when the mobile communication terminal is connected to the protective casing's interface, automatically puts a displayed item on a display on the mobile communication terminal into a desired orientation with respect to the protective casing's input and/or output device.

7. A set, particularly as claimed in claim 5 or 6, comprising a mobile communication terminal (2, 4) and a protective casing (1, 3), where the protective casing has an input and/or output device (5) and an interface for transmitting signals between the input and/or output device (5) and the mobile communication terminal (2, 4), characterized in that the mobile communication terminal has, on a front side, a first display for use with an integrated input device on the mobile communication terminal and, on a rear side, a second display for use with the protective casing's input and/or output device.

8. The set as claimed in claim 7, characterized in that the mobile communication terminal has a changeover device which, when the mobile communication terminal is connected to the protective casing's interface, automatically changes over from the first display to the second display.
